(19) United States
(12) Patent Application Publication
(10) Pub. No.: US 2011/0191026 A1
(43) Pub. Date: Aug. 4, 2011

(54) BROADCAST SIGNAL RECEIVER HAVING MONITORING FUNCTION OF SOLAR CELL MODULE

(76) Inventor: Heesoo MOON, Seoul (KR)

(21) Appl. No.: 13/013,637

(22) Filed: Jan. 25, 2011

(30) Foreign Application Priority Data
Feb. 3, 2010 (KR) 10-2010-0010039

(51) Int. Cl. G06F 19/00; G06F 3/048; H04L 27/00

(52) U.S. Cl. 702/3; 702/62; 715/810; 375/259

(57) ABSTRACT

A broadcast signal receiver includes a first input unit receiving information of solar cell module producing power, a storage unit storing the information of the solar cell module, a second input unit receiving a broadcast signal, and an output unit outputting the broadcast signal and the information of the solar cell module, wherein the information of the solar cell module is transmitted via a predetermined communication standard and the broadcast signal is transmitted via a digital broadcast standard.

This application claims priority to and the benefit of Korean Patent Application No. 10-2010-0010039 filed in the Korean Intellectual Property Office on Feb. 3, 2010, the entire content of which is incorporated herein by reference.

### BACKGROUND OF THE INVENTION

1. Field of the Invention

Embodiments of the invention relate to a broadcast signal receiver having a monitoring function of a solar cell module.

2. Description of the Related Art

A solar cell module includes a solar cell that converts solar light energy into electrical energy and an inverter that converts DC power generated by the solar cell into AC power.

The solar cell module can be applied to a stand-alone system that stores generated electric power in a storage battery and uses the stored electric power when necessary, and a grid-connected system that supplies generated electric power to a load and supplies surplus electric power to an electric power system or grid.

### SUMMARY OF THE INVENTION

In one aspect, there is a broadcast signal receiver including a first input unit receiving information of solar cell module producing power, a storage unit storing the information of the solar cell module, a second input unit receiving a broadcast signal, and an output unit outputting the broadcast signal and the information of the solar cell module, wherein the information of the solar cell module is transmitted via a predetermined communication standard and the broadcast signal is transmitted via a digital broadcast standard.

In another aspect, there is a broadcast signal receiver including an input unit receiving a broadcast signal and information of a solar cell module that produces power according to a user's identification information through the Internet, a decoder decoding the broadcast signal and the information of the solar cell module, and an output unit outputting the information of the solar cell module.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention. In the drawings:

FIGS. 1 to 17 are views related to a broadcast signal receiver having a monitoring function of a solar cell module according to an embodiment of the present invention; and

FIGS. 18 and 19 are views related to a broadcast signal receiver having a monitoring function of a solar cell module according to another embodiment of the present invention.

### DETAILED DESCRIPTION OF THE EMBODIMENTS

Embodiments of the present invention will now be described in detail with reference to the accompanying drawings. The invention may, however, be embodied in many different forms and should not be construed as being limited to the embodiments set forth herein. In order to clarify the present invention, portions unrelated to the description are omitted and like reference numerals designate like elements throughout the specification.

A broadcast signal receiver outputting information of a solar cell module according to an embodiment of the present invention will now be described in detail with reference to the accompanying drawings.

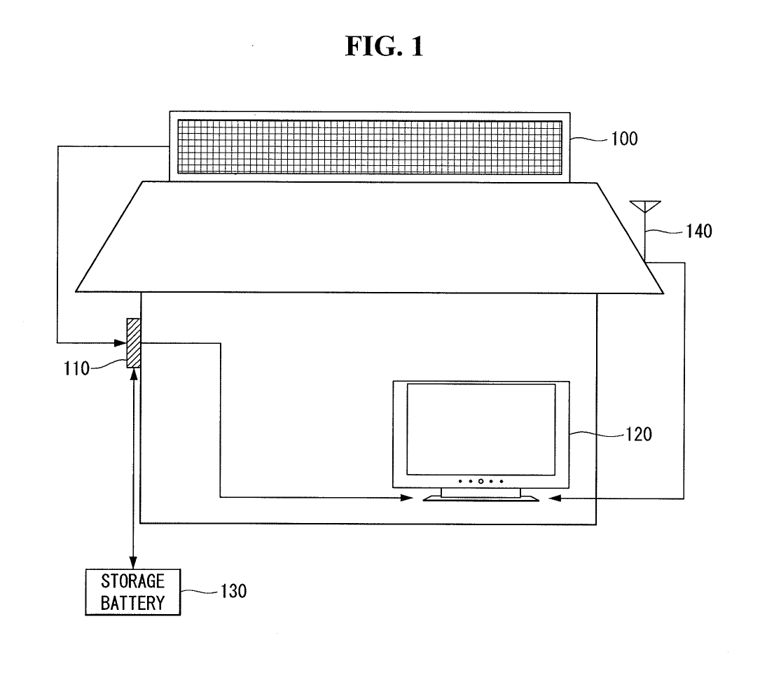

FIGS. 1 to 17 are views related to a broadcast signal receiver having a monitoring function of a solar cell module according to an embodiment of the present invention. With reference to FIG. 1, a broadcast signal receiver according to an embodiment of the present invention may receive information of a solar cell module 100, producing electric power from incident light, such as sunlight, through an inverter 110, and output the received information. The solar cell module 100 may produce DC electric power by converting the incident light into electrical energy. The solar cell module 100 may include at least one solar cell.

When light is made incident from the exterior, electron-hole pairs are formed within semiconductor of the solar cell by the incident light, and the electrons move to an n-type semiconductor and holes move to a p-type semiconductor by an electric field generated therein, thus producing electric power. The inverter 110 may convert the DC power produced by the solar cell module 100 into AC power. Also, the inverter 110 may generate information of power production of the solar cell module 100. The power produced by the solar cell module 100 may be stored in a storage battery 130. According to circumstances, surplus power remaining after consuming the produced power may be stored in the storage battery 130.

The structure in which the produced power is stored in the storage battery 130 may be called a stand-alone system. Differently, a user may supply the produced power or the surplus power remaining after using the produced power to an electric power system or grid, e.g., an electric power company. In this instance, the user may sell the surplus power. This structure may be called a grid-connected system. The grid-connected system may include a distributing board (or a switch board) in order to supply produced power to the electric power system or grid.

The distributing board may transmit produced power to the outside (e.g., the electric power system or grid, or the electric power company) according to the amount of power produced by the solar cell module 100. The distributing board may transmit the information of the solar cell module 100 and the information of the produced power to a device, such as an eternal server.

The broadcast signal receiver 120 according to an embodiment of the present invention may be applied to both the stand-alone system and the grid-connected system. The broadcast signal receiver 120 (e.g., a television) may output an image, a sound (such as voice), and data according to an input broadcast signal, and output the information of the solar cell module 100, e.g., the information of the produced power. Other examples of the broadcast signal receiver 120 includes computers or communication devices, such as smart phones.

The broadcast signal receiver 120 may receive a broadcast signal through an antenna 140, or through a cable. In addition, the broadcast signal receiver 120 may output the information of the solar cell module 100 in a format of at least one of a voice and an image. Then, the user is able to easily monitor the information of the solar cell module 100 by using the broadcast signal receiver 120

Accordingly, because there is no need to additionally include a monitoring device for monitoring the information of the solar cell module 100, cost can be reduced. In addition, because the broadcast signal receiver 120 is disposed at a location having good accessibility, such as in a living area of a dwelling, the accessibility of the information of the solar cell module 100 can be improved.

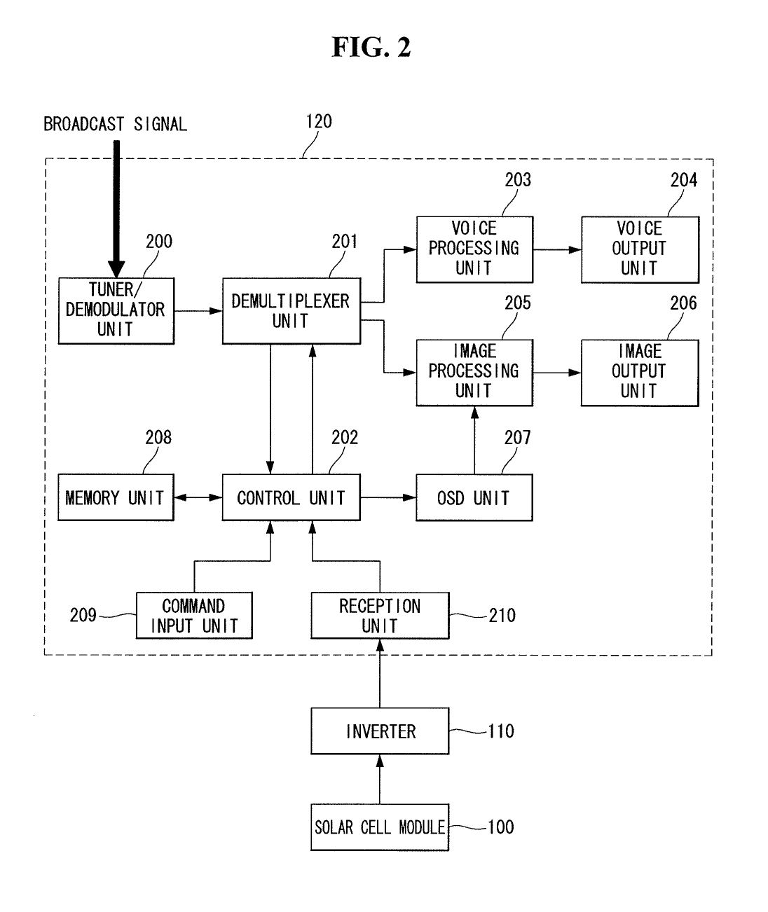

The configuration of the broadcast signal receiver according to an embodiment of the present invention will now be described in detail with reference to FIG. 2. With reference to FIG. 2, the broadcast signal receiver 120 may include a tuner/demodulator unit 200, a demultiplexer unit 201, a control unit 202, a voice (or sound) processing unit 203, a voice (or sound) output unit 204, an image processing unit 205, an image output unit 206, an on screen display (OSD) unit 207, a memory unit 208, a command input unit 209, and an input unit (or a reception unit) 210.

The input unit 210 may receive the information of the solar cell module 100 from the inverter 110 through a fixed line or wirelessly. The input unit 210 may be referred to as a first input unit because it receives the information of the solar cell module 100. In embodiments of the present invention, communication between the input unit 210 and the solar cell module 100 or the inverter 110 may be by way of a predetermined communication standard, such as any wired or wireless communication standard, and which may include TCP/IP, LAN (local area network), HAN (home area network), smart meter technology, WiFi, mesh network, or other communication standards.

The tuner/demodulator unit 200 may receive a broadcast signal transmitted from a broadcast station and demodulate the received broadcast signal. Because the tuner/demodulator unit 200 receives the broadcast signal, it may be referred to as a second input unit. In embodiments of the present invention, the broadcast signal may be any of the signals complying with the digital television broadcast standard, such as ATSC, for example. In addition, because the tuner/demodulator unit 200 demodulates the received broadcast signal, it may be referred to as a decoder. In embodiments of the present invention, the predetermined communication standard may be a non-digital television broadcast standard.

The demultiplexer unit 201 may separate the received broadcast signal into an image signal, a voice signal (or sound signal), and a data signal. The voice processing unit 203 may process the voice signal separated by the demultiplexer 201 into an audible signal. The voice output unit 204 may output the voice signal processed by the voice processing unit 203. The voice output unit 204 may be a speaker.

The image processing unit 205 may process the image signal separated by the demultiplexer 201 into a signal that can be viewed. The image output unit 206 may output the image signal processed by the image processing unit 205. The image output unit 206 may be a monitor or a display. The OSD unit 207 may output a signal of a certain character, text, diagram, graphics, and the like, namely, an OSD signal, to be displayed on the image output unit 206. Hereinafter, the signal output by the OSD unit 207 may be referred to as an OSD signal.

In addition, the OSD unit 207 may generate the OSD signal according to the information of the solar cell module 100 and transmit the same to the image processing unit 205. The OSD unit 207 may generate the information of the solar cell module 100 in the form of a widget. In embodiments of the present invention, the widget may refer to an element of a graphic user interface (GUI) that displays an information arrangement that is changeable by a user.

Then, the image processing unit 205 may synthesize the OSD signal (or a widget signal, though it will be also referred to as an ‘OSD signal’, hereinafter) according to the information of the solar cell module 100 and the image signal according to the broadcast signal, and output the signal synthesized by the image output unit 206 such that it can be viewed.

The control unit 202 may control receiving and viewing of the broadcast signal by controlling each element 200, 201 and 203 to 210, and also control outputting of the information of the solar cell module 100. Also, the control unit 202 may calculate the estimated amount of electric power by using a certain algorithm. This will be described in detail hereinafter.

The memory unit 208 may store the information of the broadcast signal and various information of the solar cell module 100. Also, the memory unit 208 may store the information of the solar cell module 100 according to a certain period. This memory unit 208 may be referred to as a data storage unit.

The command input unit 209 may input a command according to a user manipulation. A keyboard, a remote controller, or the like, may be applied as the command input unit 209. The voice output unit 204 may output a voice signal according to a broadcast signal, or may output information of produced power of the solar cell module 100 in the form of a voice. The voice output unit 204 may output other sounds as well.

Furthermore, the image output unit 206 may output an image signal according to a broadcast signal, or may output information of the solar cell module 100 in the form of an image. Also, the voice output unit 204 and the image output unit 206 may be commonly designated as an image/voice output unit. In other embodiments, the functions of the voice output unit 204 and the image output unit 206 may be performed by a single unit referred to as an image/voice output unit.

Meanwhile, the inverter 110 may convert DC power produced by the solar cell module 100 into AC power and supply the converted AC power to the broadcast signal receiver 120. Accordingly, the broadcast signal receiver 120 may output the information of produced power of the solar cell module 100 in the form of a voice or an image to allow the user to monitor the solar cell module, and may be operated with the power produced by the solar cell module 100.

Also, the inverter 110 may supply a portion or the entirety of the DC power produced by the solar cell module 100 to the electric power system or grid. Alternatively, the inverter 110 may supply a portion or the entirety of power produced by the solar cell module 100 to the storage battery so as to be stored therein. Also, the inverter 110 may be connected to the solar cell module 100 to generate the information of the solar cell module 100, e.g., information of the amount of produced power, the accumulated amount of produced power, and the like. To this end, the inverter 110 may generate at least one of information of current amount of electric power generation, information of the amount of electric power generation by period, information of the amount of electric power generation by hour, information of the unit cost of power, information of the amount of reduced CO₂, information of the total accumulated amount of electric power, and information of electric power generation efficiency. Other information of the solar cell module 100 may be further provided.

When the user inputs a command for searching for the information of the solar cell module 100 by using the command input unit 209 while viewing a certain image displayed on the image output unit 206, such as a broadcast program, the OSD unit 207 may generate an OSD signal according to the information of the solar cell module 100 generated by the inverter 110 under the control of the control unit 202. Also, the OSD signal according to the information of the solar cell module 100 may be processed by the image processing unit 205 and synthesized to the image currently being viewed by the user.

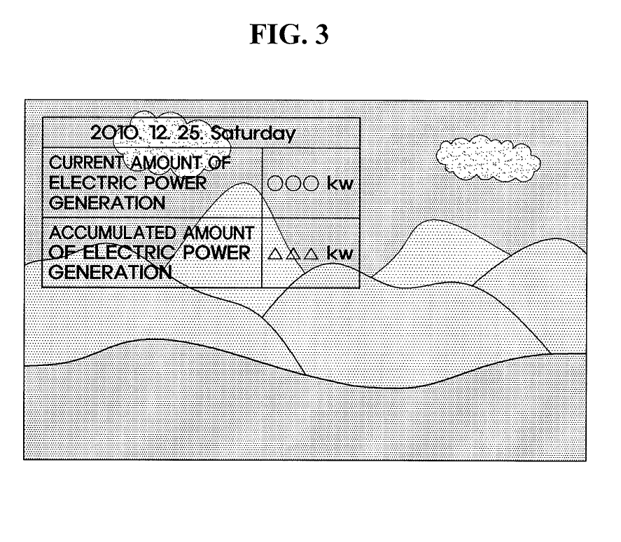

The synthesized signal may be output by the image output unit 206 according to the method as shown in FIG. 3. With reference to FIG. 3, it is noted that the information of power production of the solar cell module 100 is displayed at a left upper portion of the screen displaying an image, as an example. For effective monitoring, preferably, but not necessarily, the information of the power production of the solar cell module 100 may include dates, the current amount of electric power, the accumulated amount of electric power, and the like.

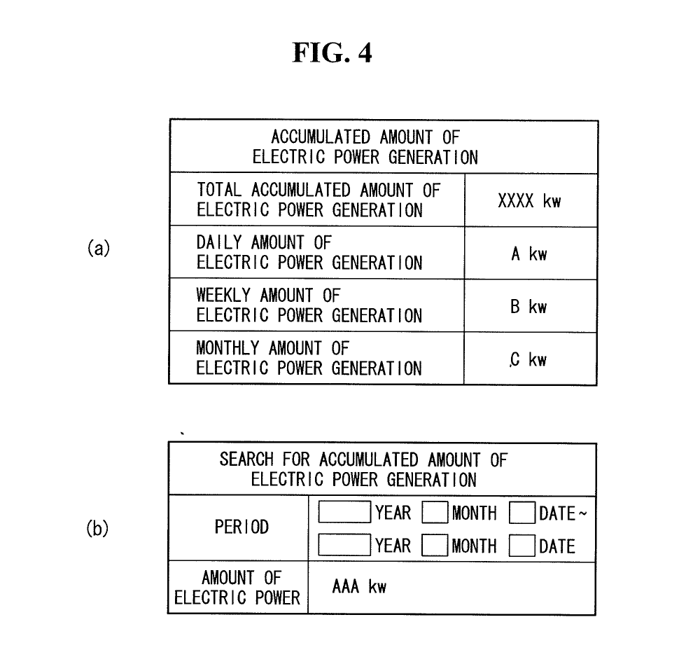

In addition, as shown in (a) of FIG. 4, the information of the accumulated amount of electric power may include information of the total accumulated amount of electric power generation, and information of the accumulated amount of electric power generation according to a certain period, e.g., information of a daily amount of electric power generation, information of a weekly amount of electric power generation, and information of a monthly amount of electric power generation.

Alternatively, as shown in (b) of FIG. 4, a time period for searching for the information of the accumulated amount of electric power generation may be set, and information of the accumulated electric power generation according to the set time period may be searched. For example, the user may set year, month, date, and the like, at a portion designated for the time period as shown in (b) of FIG. 4 and search for information of the accumulated amount of electric power generation for the set time period.

Alternatively, the information of the solar cell module 100 may include information of the amount of electric power generation by hour. Meanwhile, the broadcast signal may include weather information.

Weather information may include cloud information (such as cloud cover information), information of the amount of sunshine, and information of duration of sunshine. Also, the weather information may further include temperature information, humidity information, rainfall probability information, wind speed information, and wind direction information.

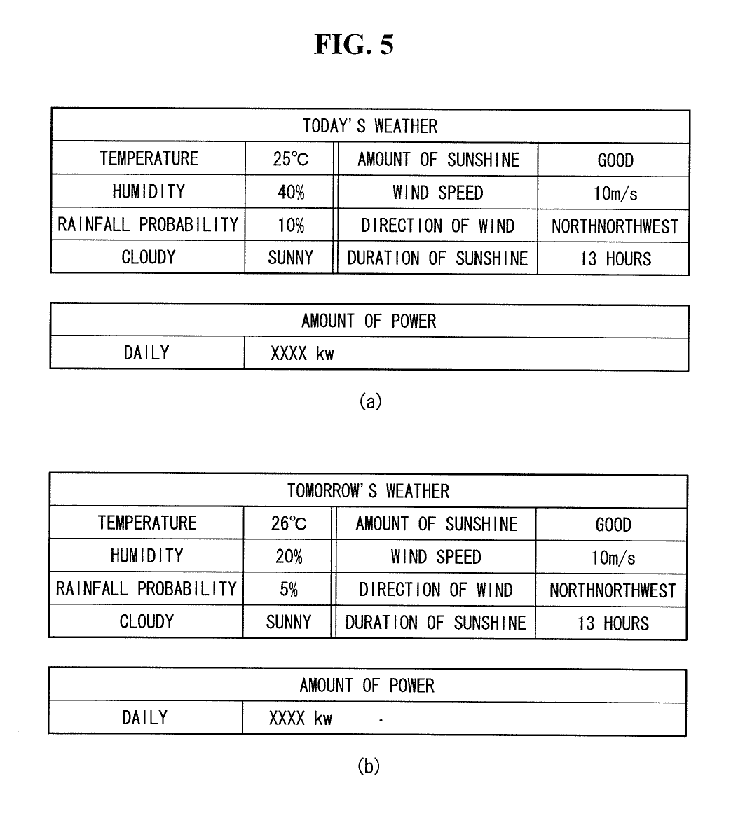

In addition, the information of the solar cell module 100 may include information of power produced by the solar cell module 100 according to today's weather (or current weather) as shown in (a) of FIG. 5.

The information of the amount of power in (a) of FIG. 5 is that, after the duration of sunshine is terminated, the amount of power produced for a day is matched to or correlated with the today's weather. By matching the weather information to the information of the solar cell module 100, the user can estimate the amount of power production according to weather.

In addition, the information of the solar cell module 100 may include information of an estimated amount of power to be produced by the solar cell module 100 according to tomorrow's weather (future weather or expected weather) as shown in (b) of FIG. 5. The estimated amount of power for tomorrow may be estimated by the control unit 202 according to a forecast of the tomorrow's weather (future weather or expected weather).

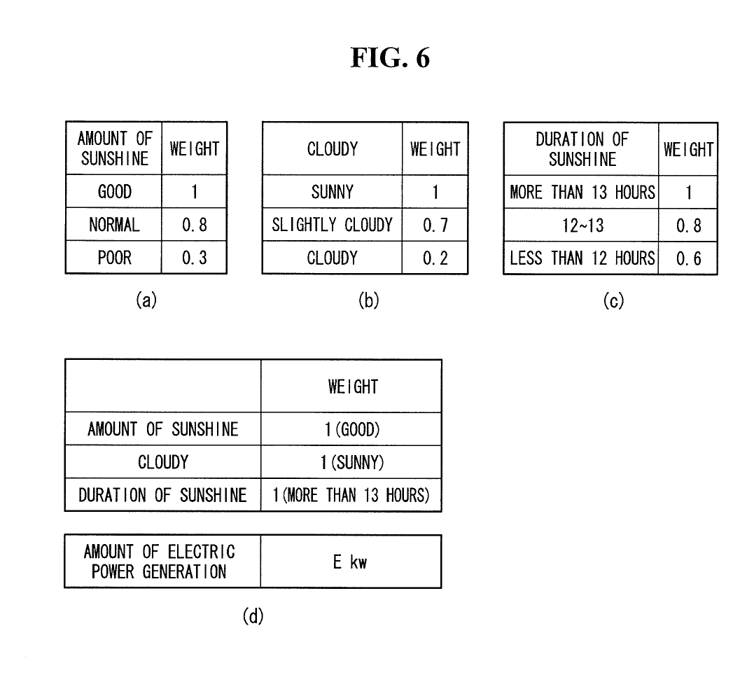

The estimated amount of power according to tomorrow's weather may be calculated by adding weight to each of weather items. For example, as shown in (a) of FIG. 6, a weight value of 1 may be assigned to ‘good’, a weight value of 0.8 may be assigned to ‘normal’, and a weight value of 0.3 may be assigned to ‘poor’, according to the degree of the amount of sunshine.

Also, as shown in (b) of FIG. 6, a weight value of 1 may be assigned to ‘sunny’, a weight value of 0.6 may be assigned to ‘slightly cloudy’, and a weight value of 0.2 may be assigned to ‘cloudy’. Here, ‘slightly cloudy’ and ‘cloudy’ may be a cloudy weather sufficient for generating solar light. If it's rainy, snowy, or very cloudy, it is substantially difficult to generate solar light. Thus, such an instance must be considered. Also, as shown in (c) of FIG. 6, a weight value of 1 may be assigned to more than 13 hours, a weight value of 0.8 may be assigned to 12 to 13 hours, and a weight value of 0.6 may be assigned to less than 12 hours, according to the length of the duration of sunshine.

In addition, when the amount of sunshine is good, the cloud state is sunny, and the duration of sunshine is more than 13 hours, the amount of electric power generation of the solar cell module 100 may be set to be maximum (Ekw), and when the weather becomes worse, a corresponding weight value may be applied to calculate the estimated amount of electric power generation according to the tomorrow's weather. For example, when the forecast of tomorrow's weather is that the amount of sunshine is good, the cloud state is sunny, and the duration of sunshine is 12 hours, a weight value of 0.8, rather than 1, with respect to the duration of sunshine is applied thereto, so that the estimated amount of electric power generation according to tomorrow's weather is smaller than the maximum amount of electric power generation (Ekw).

In such an instance, the memory unit 208 of the broadcast signal receiver 120 stores the respective weather items and corresponding weight information, and also store a calculation algorithm for obtaining the estimated amount of electric power generation.

The weather items and the corresponding weights as shown in FIG. 6 are arbitrarily set, and the present invention is not limited thereto and the weather items and corresponding weights may be changed.

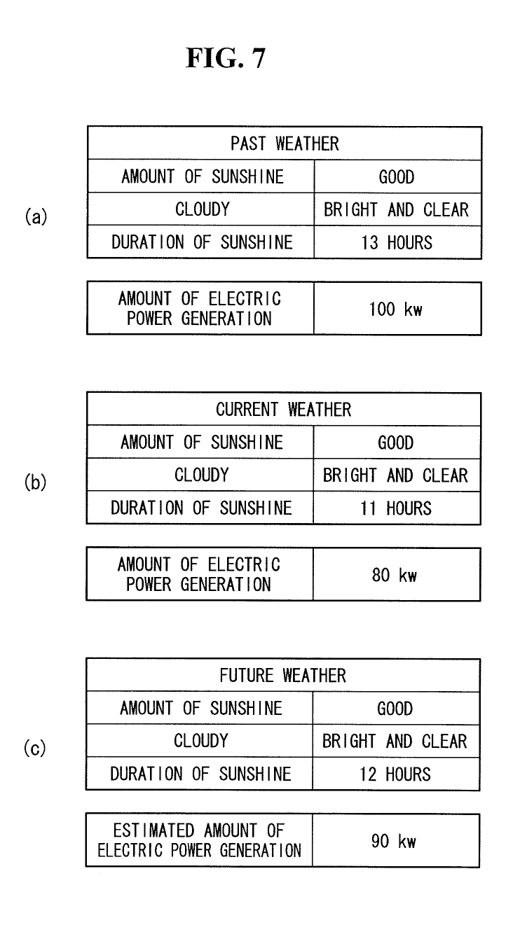

Also, the information of the solar cell module 100 may include the past or current power production information of the solar cell module 100 and power production information of the solar cell module 100 estimated by using the weather information. For example, when it is assumed that the weather of a day in the past (past weather) was when the amount of sunshine was good, a cloud state was bright and clear, the duration of sunshine was 13 hours, and the amount of electric power generation was 100 kw as shown in (a) of FIG. 7, and a current weather is where the amount of sunshine is good, a cloud state is bright and clear, the duration of sunshine is 11 hours, and the amount of electric power generation is 80 kw as shown in (b) of FIG. 7.

In such an instance, when the forecast of a future weather is that the duration of sunshine is to be good, the cloud state is to be bright and clear, and the duration of sunshine is to be 12 hours as shown in (c) of FIG. 7, the duration of sunshine is one hour less than the case of (a) of FIG. 7 and one hour more than the case of (b) of FIG. 7. Thus, the estimated amount of electric power generation according to the future weather forecast as shown in (c) of FIG. 7 may be estimated to be smaller than the amount of electric power generation according to the weather of (a) of FIG. 7 and greater than the amount of electric power generation according to the weather of (b) of FIG. 7. For example, the estimated amount of electric power generation is calculated to be substantially 90 kw.

Meanwhile, weather information may be included in a broadcast signal. Alternatively, weather information may be received from the Internet or may be included in a broadcast signal.

Also, when there is an error in an output of the solar cell module as well as in a menu selection according to a user's designation, for example, when an abnormal output is generated because a light incident surface of the solar cell is covered with leafage, dust, and the like, a warning message may be provided. In this instance, a warning image may be automatically generated according to a solar cell output, rather than a user selection. That is, given an expected amount of electric power to be generated for a given a condition or weather (forecasted or expected condition or weather), if the actual amount of electric power that is generated is lower than the expected amount, a warning may be output. The warning may be output if the actual amount of electric power is lower than the expected amount by a preset amount, for example.

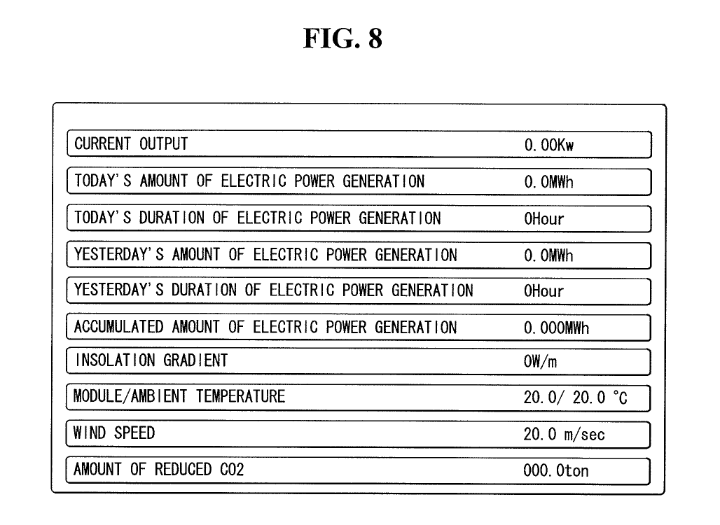

Examples of the information of the solar cell module 100 displayed on the image output unit 26 are shown in FIGS. 8 to 10. With reference to FIGS. 8 to 10, the information of the solar cell module 100 may be displayed in various forms.

The information of the solar cell module 100 may be displayed by numeric values. For example, as shown in FIG. 8, among the information of the solar cell module 100, such numeric values may include a current output, today's amount of electric power generation, today's duration of electric power generation, yesterday's amount of electric power generation, yesterday's duration of electric power generation, the accumulated amount of electric power generation, an insolation gradient, a module/ambient temperature, a wind speed, and the amount of reduced CO₂.

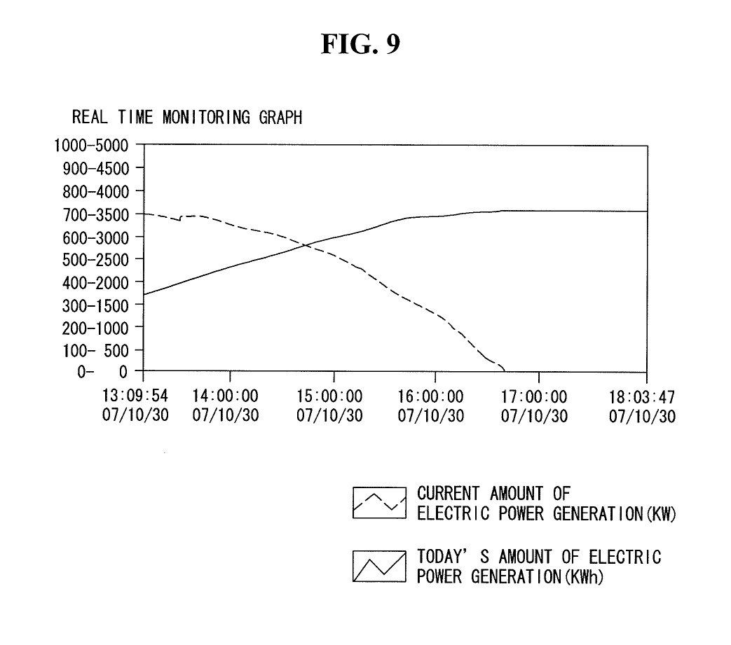

Alternatively, the information of the solar cell module 100 may be displayed in the form of a graph. For example, as shown in FIG. 9, the current amount of electric power generation and today's electric power generation, of the information of the solar cell module 100 may be displayed as graphs on the screen.

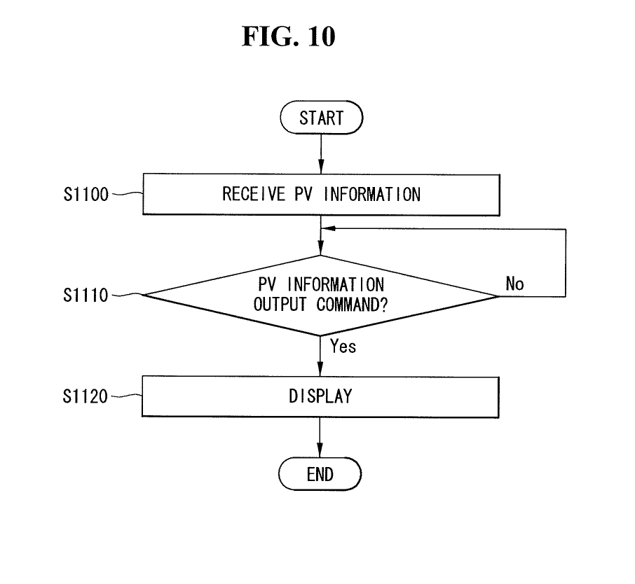

Meanwhile, the information of the solar cell module 100 may be output in the form of at least one of an image or a voice according to a user selection, or may be output regardless of the user selection. For example, as shown in FIG. 10, when information (such as photovoltaic (PV) information) of the solar cell module 100 is received, the control unit 202 may determine whether or not a command of outputting the information of the solar cell module 100 is input (S1110).

When the user inputs a command for outputting the information of the solar cell module 100 through a command input unit 209, the image output unit 206 may display the information of the solar cell module 100 on the screen, or the voice output unit 204 may output the information of the solar cell module 100 in the form of a voice or sound.

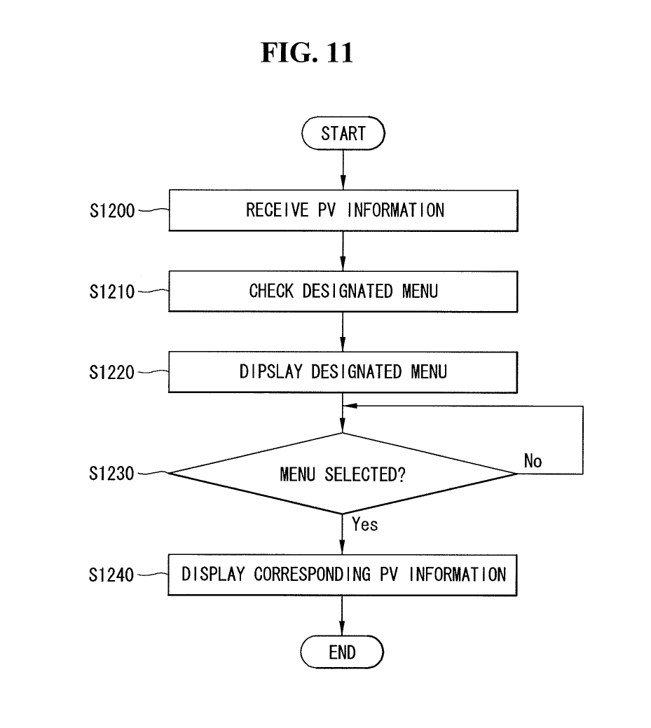

As shown in FIG. 10, the information of the solar cell module 100 may be output only when a user's command is input. Also, as shown in FIG. 11, when the information (PV information) of the solar cell module 100 is received (S1200), the control unit 202 may check a previously designated menu (designated menu) (S1210). When there is no designated menu, the method as shown in FIG. 10 may be performed.

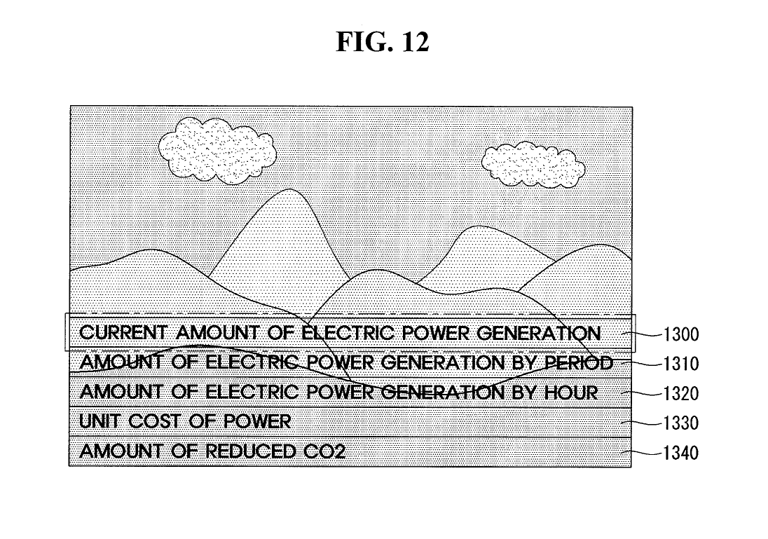

A designated menu checked by the control unit 202 may be displayed on the image output unit 206 (S1220). For example, as shown in FIG. 12, the current amount of electric power generation 1300, the amount of electric power generation by period 1310, the amount of electric power generation by hour 1320, the unit cost of power 1330 and/or the amount of reduced CO₂ 1340 may be displayed regardless of a user's command. Here, the current amount of electric power generation 1300, the amount of electric power generation by period 1310, the amount of electric power generation by hour 1320, the unit cost of power 1330, and the amount of reduced CO₂ 1340 are designated menus. In an embodiment of the present invention, the designated menus 1300 to 1340, for example, may be displayed in a foreground of a background image. The displayed background image may be an image that represents a condition for the current amount of electric power generation 1300, such as cloud information, information of the amount of sunshine, and information of duration of sunshine, and/or may further represent temperature information, humidity information, rainfall probability information, wind speed information and/or wind direction information. The background image may also be current outside image, a predetermined picture image, or a broadcast program, or a combination of various such images.

Referring back to FIG. 11, thereafter, it may be determined whether or not a certain menu has been selected by the user from among designated menus 1300 to 1340 displayed on the screen (S1230).

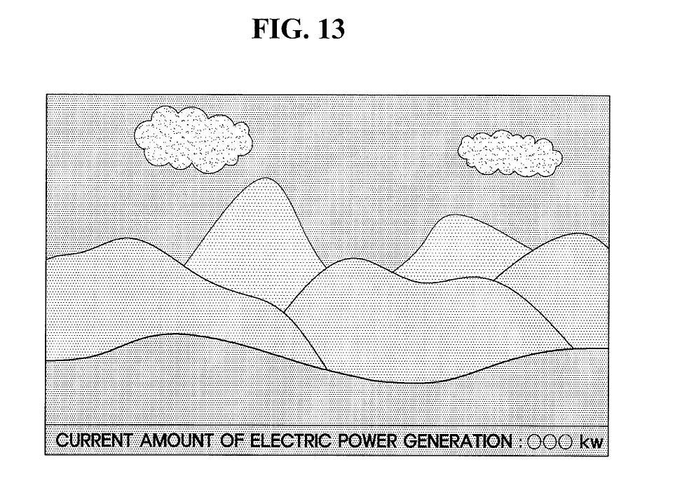

When a certain designated menu has been selected, information of the solar cell module 100 corresponding to the selected designated menu may be output to the screen (S1240). For example, when the current amount of electric power generation 1300 among the designated menus is selected, detailed information of the current amount of electric power generation 1300 is displayed on the screen as shown in FIG. 13.

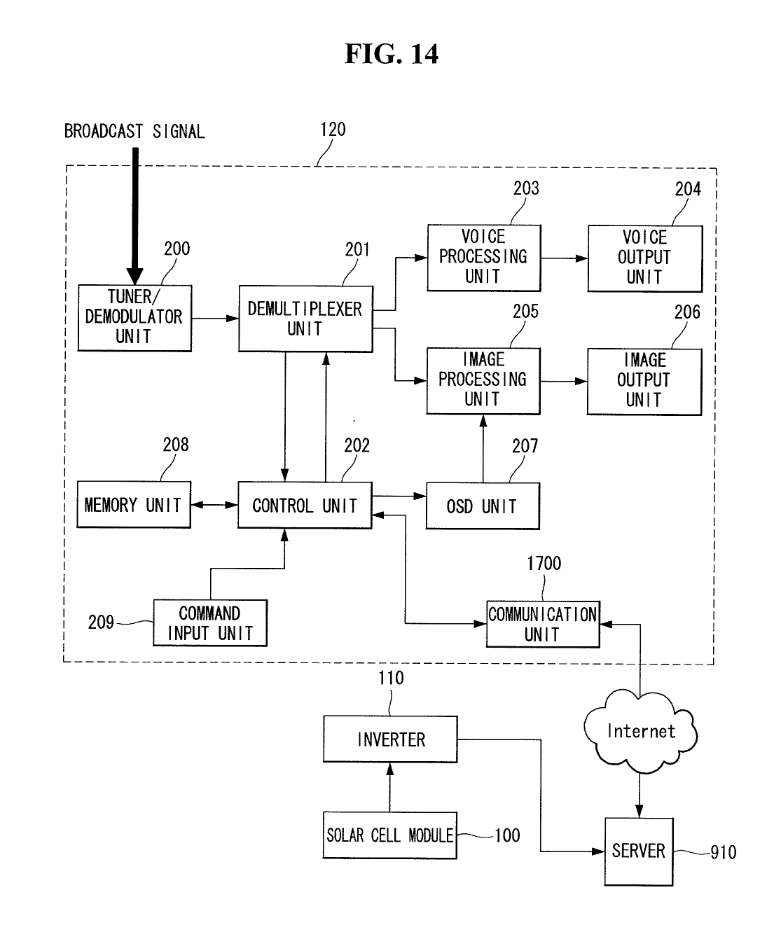

With reference to FIG. 14, the broadcast signal receiver 120 according to another embodiment of the present invention may include a communication unit 1700 that transmits and receives information to and from an Internet server 910. In such an instance, the inverter 110 may transmit the information of the solar cell module 100 to the Internet server 910, and the broadcast signal receiver 120 may receive the information of the solar cell module 100 from the Internet server 910 by using the communication unit 1700. Also, in the instance as shown in FIG. 14, the weather information may be received from the Internet server 910 by using the communication unit 1700.

When the weather information is received through the Internet, for example from the Internet server 910, even if a broadcast signal does not include weather information, an estimated amount of power may be calculated according to a forecast of future weather received from through the Internet.

Although separately displayed, in case of an IPTV, a broadcast signal and the information of the solar cell module may be received through the Internet.

The solar cell module according to an embodiment of the present invention may be configured to be incorporated in a distributing system of a smart grid. In this instance, the information of the solar cell module may be easily transmitted along with user information to the Internet server by using a communication system of the distributing system, and the information of the solar cell module may be received along with information of power of the smart grid to the user's broadcast signal receiver according to a corresponding user request.

Power information that can be checked by a smart meter using a communication protocol such as ZigBee™, and the like, can be easily monitored by using the broadcast signal receiver system according to an embodiment of the present invention. Also, the communication protocol of the smart grid can be also used for communication at the level of the solar cell module.

Also, the user may request the information of the solar cell module 100 through the command input unit 209, and receive the information of the solar cell module 100 according to the corresponding request.

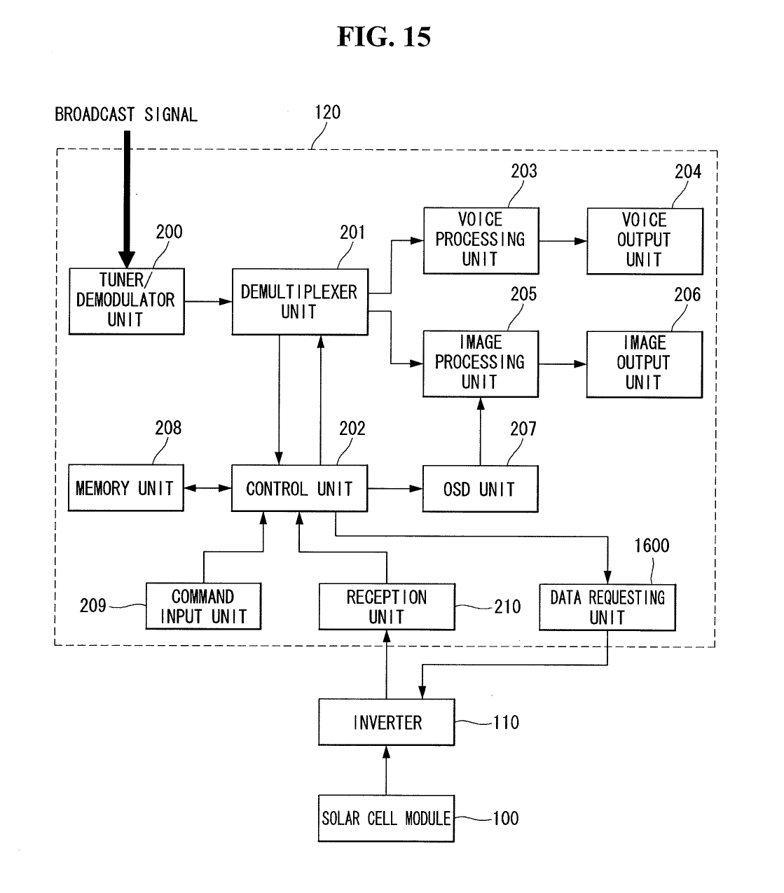

For example, as shown in FIG. 15, the broadcast signal receiver 120 according to another embodiment of the present invention may include the reception unit 210 and a data requesting unit 1600.

The data requesting unit 1600 may request the inverter 110 to transmit the information of the solar cell module 100 according to a user input. In response to the request from the data requesting unit 1600, the inverter 110 may transmit the information of the solar cell module 100, and the input unit 210 may receive the information. Also, the broadcast signal receiver 120 may receive the information of the solar cell module 100 in the form of an RF signal.

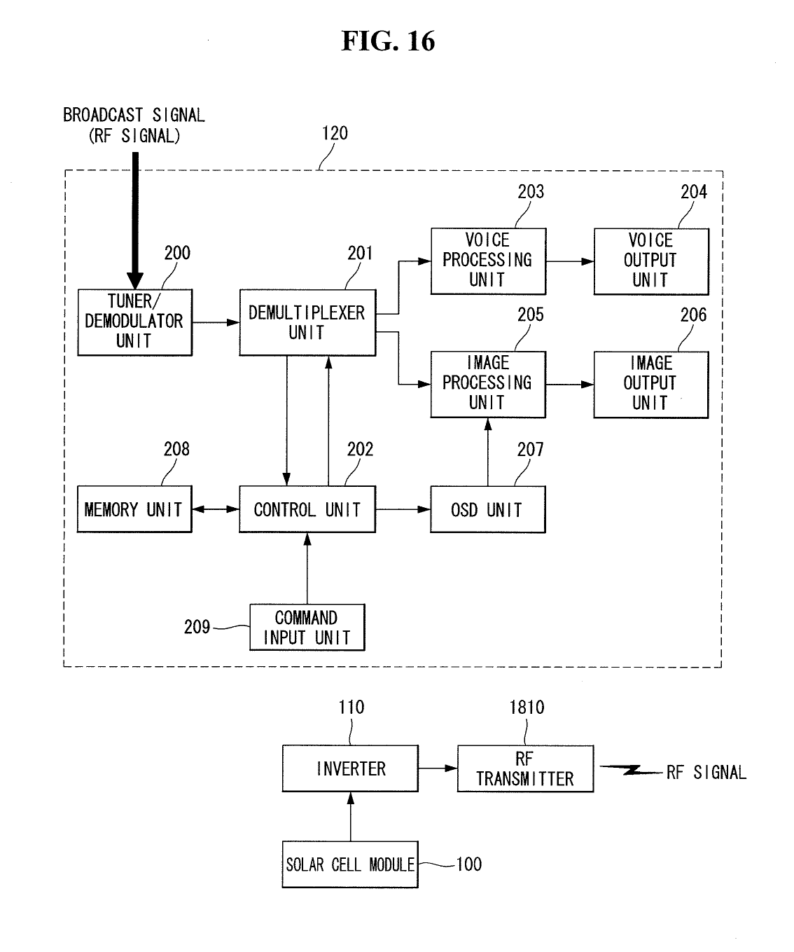

To this end, as shown in FIG. 16, the broadcast signal receiver 120 includes a tuner/demodulator unit 200 that selectively receives a broadcast signal including information of the solar cell module in the form of an RF signal and processes the same, the voice processing unit 203 that processes a voice signal separated from the demodulated signal, the voice output unit 204 that outputs a voice signal, the image processing unit 205 that processes the image signal separated from the demodulated signal, and the image output unit 206 that outputs the image signal.

With this configuration noted above, when monitoring of a solar cell system is done by town, and monitoring is not individually required on an individual house, apartment house or building, information of the overall generation system or the information of the solar cell module installed in individual houses may be created as a broadcast signal and transmitted to each house, and each house may select a channel of the solar cell information and monitor it. Namely, the information of the solar cell module 100 may be allocated to a particular channel and transmitted, and when the particular channel is selected, the information of the solar cell module 100 can be output.

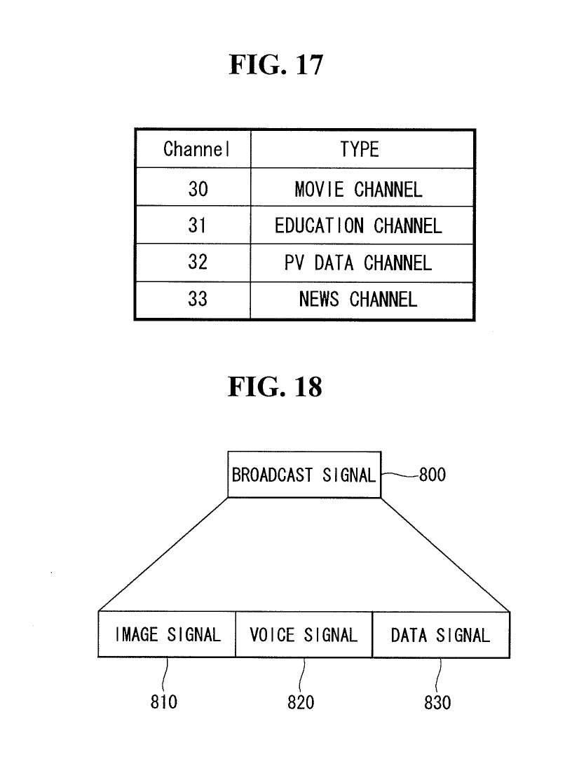

For example, as shown in FIG. 17, it is assumed that channel 30 is assigned as a movie channel, channel 31 is assigned as an education channel, channel 32 is assigned as information channel (PV data channel) of a solar cell module, and channel 33 is assigned as a news channel. In such an instance, when the user selects channel 32, the image output unit 206 may output the information of the solar cell module 100 to the screen, and accordingly, the user may easily check the information of the solar cell module 100 by a simple method of selecting the channel 32. An instance in which the information of the solar cell module 100 is included in a broadcast signal will now be described in detail.

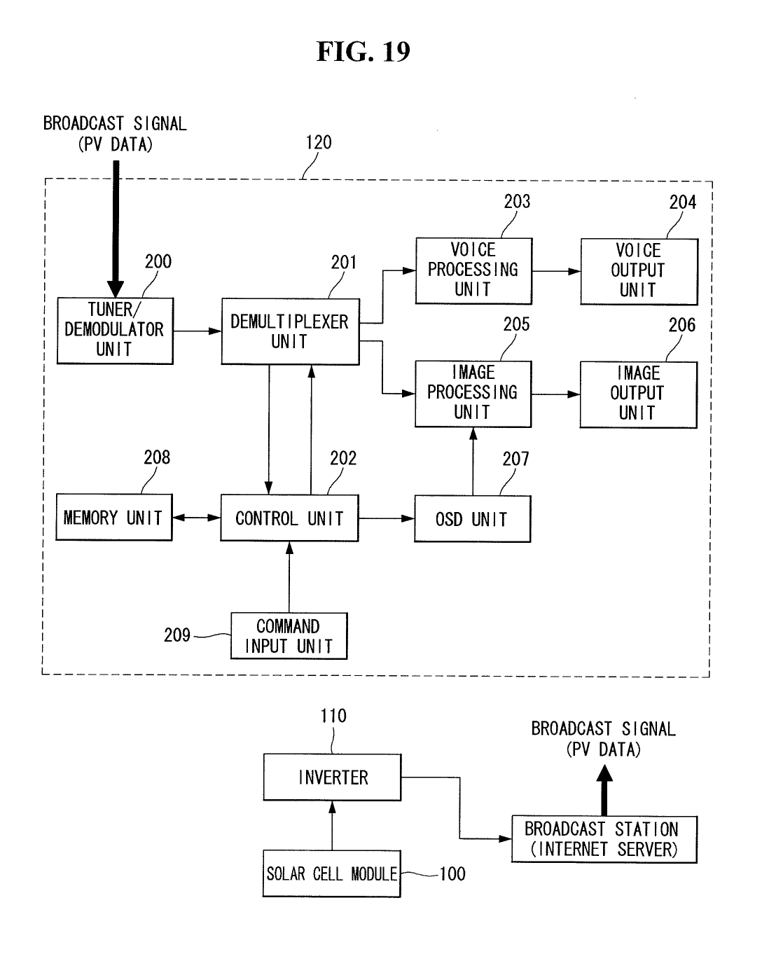

FIGS. 18 and 19 are views for explaining another example of a broadcast signal receiver having a monitoring function of a solar cell module according to an embodiment of the present invention. The views shown in FIGS. 18 and 19 are different in that the information of the solar cell module is included in a broadcast signal and transmitted, while the type of the information of the solar cell module, the method for displaying the information of the solar cell module, and the like may be substantially the same as the embodiment of FIGS. 1 to 17. Thus, hereinafter, a description of a portion which has been already described in detail will be omitted.

With reference to FIG. 18, a broadcast signal 800 may include an image signal 810, a voice signal 820, and a data signal 830. Here, the data signal 830 may include the information of the solar cell module. Namely, the information of the solar cell module may be included in the broadcast signal 800. Also, the data signal 830 may include weather information. In an instance of a data broadcast standard, the data signal 830 including various types of information such as the information of the solar cell mode, weather information, as well as the image and voice signals 810 and 820, may be transmitted.

Alternatively, the weather information may be included in the broadcast signal, but it may be also received from the Internet separately from the broadcast signal. In this instance, the information of the solar cell module may be processed by a supplementary data processing unit that processes supplementary data information from the broadcast signal in to an image, a voice, an OSD, or the like, which may be, then, output.

With reference to FIG. 19, the broadcast signal receiver 120 may receive a broadcast signal including information (PV data) of the solar cell module 100. To this end, the inverter 110 may transmit the information of the solar cell module 100 to a broadcast station (or the Internet server in case of an Internet broadcast).

Then, the broadcast station may add various types of data such as the information of the solar cell module 100, or the like, and transmit the same to a user. For example, the information of the solar cell module 100 may be included in an electric program guide (EPG) and transmitted. Meanwhile, the information of the solar cell module 100 may be output according to a user's channel selection. In detail, the information of the solar cell module 100 may be selected by a particular menu, transmitted from the corresponding server to a broadcast receiving unit, and the information of the solar cell module 100 may be output.

The broadcast signal receiver 120 that receives a broadcast signal through the Internet may be, for example, an IPTV. When the IPTV is applied to the present invention, the broadcast signal receiver 120 may receive the information of the solar cell module 100 that produces electric power and the broadcast signal through the Internet. Preferably, but not necessarily, the broadcast signal receiver 120 may receive the broadcast signal including the information of the solar cell module 100 according to user's identification information from the Internet. Here, the user's identification information may be an IP address.

An information provider, e.g., the Internet server, may include the information of the solar cell module according to identification information of each user, e.g., each user's IP address, in the broadcast signal and transmit the same. Then, the user may decode the information of the solar cell module 100 corresponding to his identification information and use the decoded information of the solar cell module.

Although embodiments have been described with reference to a number of illustrative embodiments thereof, it should be understood that numerous other modifications and embodiments can be devised by those skilled in the art that will fall within the scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A broadcast signal receiver comprising:
a first input unit configured to receive information of a solar cell module producing power;
a storage unit configured to store the information of the solar cell module;
a second input unit receiving a broadcast signal; and
an output unit configured to output the broadcast signal and the information of the solar cell module,
wherein the information of the solar cell module is transmitted via a predetermined communication standard and the broadcast signal is transmitted via a digital broadcast standard.

2. The broadcast signal receiver of claim 1, wherein the output unit is at least one of a sound output unit and an image output unit.

3. The broadcast signal receiver of claim 1, wherein the information of the solar cell module comprises at least one of information of a current amount of electric power generation, information of an amount of electric power generation by period, information of an amount of electric power generation by hour, information of a unit cost of power, information of an amount of reduced CO₂, information of a total accumulated amount of electric power generation, and information of an electric power generation efficiency.

4. The broadcast signal receiver of claim 1, wherein at least one of the first and second input units receives weather information, and the output unit outputs the weather information along with the information of the solar cell module.

5. The broadcast signal receiver of claim 4, wherein the weather information comprises information of an amount of sunshine and information of temperature.

6. The broadcast signal receiver of claim 4, wherein the weather information is included in the broadcast signal or is separately received from the Internet.

7. The broadcast signal receiver of claim 1, wherein the information of the solar cell module is output by the output unit according to a user selection.

8. The broadcast signal receiver of claim 1, wherein the first input unit receives the information of the solar cell module through a fixed line or wirelessly.

9. The broadcast signal receiver of claim 1, wherein the storage unit stores the information of the solar cell module during a predetermined period.

10. The broadcast signal receiver of claim 1, wherein the output unit comprises an image output unit, and the image output unit displays a predetermined menu with respect to the information of the solar cell module.

11. The broadcast signal receiver of claim 10, wherein the image output unit outputs the information of the solar cell module according to a user's menu selection.

12. The broadcast signal receiver of claim 1, further comprising:
a demultiplexer unit separating the broadcast signal into a voice signal, an image signal, and a data signal according to an attribute of the broadcast signal.

13. The broadcast signal receiver of claim 1, wherein the output unit comprises an image output unit, and the image output unit displays the information of the solar cell module by using at least one of an on screen display (OSD) and a widget.

14. The broadcast signal receiver of claim 1, wherein the information of the solar cell module is received from an inverter that generates information of power produced by the solar cell module.

15. The broadcast signal receiver of claim 1, wherein the information of the solar cell module is information transmitted from an Internet server.

16. A broadcast signal receiver comprising:
an input unit configured to receive a broadcast signal and information of a solar cell module that produces power according to a user's identification information through the Internet;
a decoder configured to decode the broadcast signal and the information of the solar cell module; and
an output unit configured to output the information of the solar cell module.

17. The broadcast signal receiver of claim 16, wherein the output unit is at least one of a sound output unit and an image output unit.

18. The broadcast signal receiver of claim 16, wherein the information of the solar cell module comprise at least one of information of a current amount of electric power generation, information of an amount of electric power generation by period, information of an amount of electric power generation by hour, information of a unit cost of power, information of an amount of reduced CO₂, information of a total accumulated amount of electric power generation, and information of an electric power generation efficiency.

19. The broadcast signal receiver of claim 16, wherein the input unit receives weather information, and the output unit outputs the weather information along with the information of the solar cell module.

20. The broadcast signal receiver of claim 19, wherein the weather information comprises information of an amount of sunshine and information of temperature.

21. The broadcast signal receiver of claim 19, wherein the weather information is included in the broadcast signal or is separately received from the Internet.

22. The broadcast signal receiver of claim 16, wherein the information of the solar cell module is output by the output unit according to a user selection.

23. The broadcast signal receiver of claim 16, further comprising:
a storage unit storing the information of the solar cell module during a predetermined period.

24. The broadcast signal receiver of claim 16, wherein the output unit comprises an image output unit, and the image output unit displays a predetermined menu with respect to the information of the solar cell module.

25. The broadcast signal receiver of claim 24, wherein the image output unit outputs the information of the solar cell module according to a user's menu selection.

26. The broadcast signal receiver of claim 16, wherein the output unit comprises an image output unit, and the image output unit displays the information of the solar cell module by using at least one of an on screen display (OSD) and a widget.

27. The broadcast signal receiver of claim 16, wherein the user's identification information is an IP address.
